(19) United States
(12) Patent Application Publication
(10) Pub. No.: US 2011/0257065 A1
(43) Pub. Date: Oct. 20, 2011

(54) Detergent Composition

(76) Inventors: Alan Thomas Brooker, Newcastle upon Tyne (GB); Gregory Scot Miracle, Hamilton, OH (US); Nigel Patrick Somerville Roberts, Newcastle upon Tyne (GB); Colin Ure, Tyne & Wear (GB)

(21) Appl. No.: 13/086,606

(22) Filed: Apr. 14, 2011

Related U.S. Application Data
(60) Provisional application No. 61/325,448, filed on Apr. 19, 2010.

(51) Int. Cl. C11D 3/60; C11D 17/00

(52) U.S. Cl. 510/314

(57) ABSTRACT

Laundry detergent composition having:
a specific bleach catalyst
a hueing dye, and
a source of peracid,
   wherein the hueing dye is released faster in a wash liquor than the bleach catalyst or the source of peracid.

### CROSS REFERENCE TO RELATED APPLICATION

This application claims the benefit of U.S. Provisional Application Ser. No. 61/325,448, filed Apr. 19, 2010.

### FIELD OF THE INVENTION

The present invention concerns a laundry detergent composition comprising a specific bleach catalyst and a hueing dye. The detergent composition provides specific relative rates of release of hueing dye and the activated bleach catalyst in the wash liquor.

### BACKGROUND OF THE INVENTION

In particular when washing laundry at lower temperatures, efficient bleaching may require the addition of bleach activators such as TAED. These bleach activators react with hydrogen peroxide, which can be released from materials such as percarbonate and perborate, to form peracids. These peracids have faster bleaching kinetics at lower temperatures than the hydrogen peroxide from which they are derived. While bleaching activators such as TAED tend to be very efficient, especially at moderate temperatures, such agents are not as efficient as desired at cooler wash temperatures and can be not fully fabric friendly at certain conditions.

Recently, bleach catalysts, or bleach “boosters” have been developed. These bleaching species are “activated” by peracid to form a highly efficient and selective cold-water bleaching species. The bleach booster may be regenerated upon reaction with the stain material, and is available for further “activation” via contact with additional peracid. Hence, significant improvements in bleaching detergency can be achieved by the addition of very minor quantities of these bleach boosters or catalysts.

It may be desirable that the laundry composition comprise a hueing system. The purpose of the hueing system may be to provide white fabrics with a light off-white tint upon washing, modifying whiteness appearance and acceptance.

However, activated bleach catalysts may have a negative impact on the hueing system as they may react with the huein90

g dyes during the wash process and decolorize them. Therefore, the bleaching and hueing properties of detergent composition cannot typically be optimized at the same time.

The inventors have now found that the above mentioned problem could be alleviated when the hueing dye is released in the wash liquor relatively faster than the bleach catalyst is released and/or activated by a peracid.

Without wishing to be bound by theory, the inventors believe that while some bleach catalysts in their activated form typically have a negative impact on the hueing dye when both components are present in the wash liquor, the activated bleach catalyst of the invention has a much lower impact on hueing dyes already deposited on the fabrics.

As such, a relative faster rate of release of the hueing dye in the wash liquor may allow the hueing dye to deposit at least partially onto the fabric before the wash liquor comprises a too high level of activated bleach catalyst that could affect the hueing dye.

### SUMMARY OF THE INVENTION

According to one of its embodiment, the invention concerns laundry detergent composition comprising:
bleach catalyst of formula:

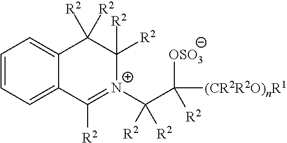

wherein R¹ is selected from the group consisting of: H, a branched alkyl group containing from 3 to 24 carbons, and a linear alkyl group containing from 1 to 24 carbons; R² is independently selected from the group consisting of: H, a branched alkyl group comprising from 3 to 12 carbons, and a linear alkyl group comprising from 1 to 12 carbons; n is an integer from 0 to 1;
hueing dye, and
a source of peracid,
   wherein either
(i) Y/X is below 0.8, with X being the weight percentage of hueing dye of the detergent composition that is released in the wash liquor after 1 min, and Y being the weight percentage of said bleach catalyst that is released in the wash liquor after 1 min, when 10 g of said laundry detergent composition are mixed with 1 l of deionised water at 25° C. to form a wash liquor, or
(ii) Z/X is below 0.8, with X being the weight percentage of hueing dye of the detergent composition that is released in the wash liquor after 1 min, and Z being the weight percentage of peracid that is released in the wash liquor after 1 min, when 10 g of said laundry detergent composition are mixed with 1 l of deionised water at 25° C. to form a wash liquor.

The detergent composition may also comprise a source of hydrogen peroxide and a bleach activator.

### DETAILED DESCRIPTION OF THE INVENTION

### Bleach Catalyst

The laundry detergent composition of the invention comprises a bleach catalyst of formula:

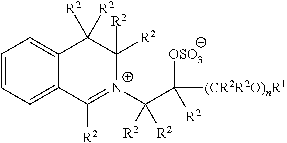

wherein:
(i) R¹ is selected from the group consisting of: H, a branched alkyl group containing from 3 to 24 carbons, and a linear alkyl group containing from 1 to 24 carbons; preferably, R¹ is a branched alkyl group comprising from 6 to 18 carbons, or a linear alkyl group comprising from 5 to 18 carbons, more preferably each R¹ is selected from the group consisting of: 2-propylheptyl, 2-butyloctyl, 2-pentylnonyl, 2-hexyldecyl, n-hexyl, n-octyl, n-decyl, n-dodecyl, n-tetradecyl, n-hexadecyl, n-octadecyl, iso-nonyl, iso-decyl, iso-tridecyl and iso-pentadecyl;
(ii) R² is independently selected from the group consisting of: H, a branched alkyl group comprising from 3 to 12 carbons, and a linear alkyl group comprising from 1 to 12 carbons; preferably R² is independently selected from H and methyl groups;
(iii) n is an integer from 0 to 1;

In one embodiment of the present invention, the bleach catalyst has a structure corresponding to general formula below:

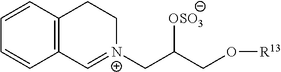

wherein R¹³ is a branched alkyl group containing from three to 24 carbon atoms (including the branching carbon atoms) or a linear alkyl group containing from one to 24 carbon atoms; preferably R¹³ is a branched alkyl group containing from eight to 18 carbon atoms or linear alkyl group containing from eight to eighteen carbon atoms; preferably R¹³ is selected from the group consisting of 2-propylheptyl, 2-butyloctyl, 2-pentylnonyl, 2-hexyldecyl, n-dodecyl, n-tetradecyl, n-hexadecyl, n-octadecyl, iso-nonyl, iso-decyl, iso-tridecyl and iso-pentadecyl; preferably R¹³ is selected from the group consisting of 2-butyloctyl, 2-pentylnonyl, 2-hexyldecyl, iso-tridecyl and iso-pentadecyl.

The laundry detergent composition of the invention may comprise from 0.0002 wt % to 5 wt % or even from about 0.001% to about 1.5%, of bleach catalyst.

This amount can typically allow the preparation of wash liquor comprising at least 0.001 ppm, from about 0.001 ppm to about 500 ppm, from about 0.005 ppm to about 150 ppm, or even from about 0.05 ppm to about 50 ppm of bleach catalyst.

The weight percentage, Y, of the bleach catalyst of the detergent composition that is released after 1 min, when 10 g of said laundry detergent composition are mixed with 1 l of deionised water at 25° C. may be measured spectrophotometrically, for example using the method below.

Method for Determination of Y: 10 g of the detergent composition (without any dye , bleach activator or preformed peracid) is added all at once at time zero (t=0) into 1 l of deionised water at 25° C. in a Terg-O-Tometer set to agitate at a rate of 100 per minute to form a wash liquor. At t=1 min, an aliquot of the wash liquor is filtered to remove undissolved particulates and 3.0 mL of filtrate is placed in a cuvette. The cuvette is spiked with 30 microliters (μL) of a 200 ppm stock solution of Solvent Yellow 43 (SY43) in ethanol to provide a final concentration of 2.0 ppm SY43. While monitoring the fluorescence emission of the dye (excitation wavelength 455 nm; emission wavelength 522 nm), an amount of 30% acetic acid solution (available from Aldrich Chemical) sufficient to establish a final concentration of peracetic acid of 100 ppm is spiked into the cuvette at time zero (t′=0) and the fluorescence emission of this test sample is monitored for an additional minute. A control sample with 3.0 mL of filtrate, 30 μL of 200 ppm SY43 ethanol stock solution and a volume of deionozed water equal to the volume of 30% acetic acid solution is prepared and its fluorescence emission intensity measured. The emission intensity of the control is F_{control}. The emission intensity of the test sample at t′=1 minute is defined as Fₚₐᵣₜᵢₐₗ. The percent of SY43 bleached by the catalyst present in the composition at t=1 minute is Yₚₐᵣₜᵢₐₗ=((F_{control}−Fₚₐᵣₜᵢₐₗ)/F_{control})×100%.

At t=30 minutes, another aliquot of the detergent solution is removed from the Terg-O-Tometer and filtered as described above. 3.0 mL of this filtrate is placed in a cuvette. The cuvette is spiked with 30 microliters (mL) of a 200 ppm stock solution of Solvent Yellow 43 (SY43) in ethanol to provide a final concentration of 2.0 ppm SY43. While monitoring the fluorescence emission of the dye (excitation wavelength 455 nm; emission wavelength 522 nm), an amount of 30% acetic acid solution (available from Aldrich Chemical) sufficient to establish a final concentration of peracetic acid of 100 ppm is spiked into the cuvette at time zero (t′=0) and the fluorescence emission of this test sample is monitored for an additional minute. The emission intensity of the test sample at t′=1 minute is defined as Fₜₒₜₐₗ. The percent of SY43 bleached by the catalyst present in the composition at t=30 minutes is Yₜₒₜₐₗ=((F_{control}−Fₜₒₜₐₗ)/F_{control})×100%.

If Yₜₒₜₐₗ is greater than or equal to 90%, the entire procedure is repeated using 50 ppm peracetic acid. If Yₜₒₜₐₗ is still greater than or equal to 90% under these conditions, the procedure is repeated as many times as needed, each time halving the level of peracid used, until a value of Yₜₒₜₐₗ less than 90% is achieved. Once this is achieved, the value of Yₜₒₜₐₗ and Yₚₐᵣₜᵢₐₗ obtained under this condition are used to calculate Y. The weight percentage, Y, of the bleach catalyst of the detergent composition that is released after 1 min is calculated as (Yₚₐᵣₜᵢₐₗ/Yₜₒₜₐₗ)×100%.

Y may be comprised between 0% and 50% and is preferably below 40%, below 30% or even below 20% or 10%.

### The Source of Peracid

The laundry detergent composition comprises a source of peracid. The source of peracid may be a bleach activator in combination with a source of hydrogen peroxide.

The ratio Z/X of the weight concentration of peracid to hueing dye in the wash liquor may be below 0.8, when 10 g of said laundry detergent composition are mixed with 1 l of deionised water at 25° C. to form a wash liquor.

The weight percentage, Z, of the peracid of the detergent composition that is released after 1 min, when 10 g of said laundry detergent composition are mixed with 1 l of deionised water at 25° C. may be measured via standard iodometric titration, for example using the method below.

10 g of the detergent composition (without any dye or catalyst) is added all at once at time zero (t=0) into 1 l of deionised water at 25° C. in a Terg-O-Tometer set to agitate at a rate of 100 per minute to form a wash liquor. Samples for analysis are withdrawn at 1, 10, 20, and 30 min. Each 100 ml sample is poured into a 600 mL beaker that contains 50 g deionized-water ice, 25 mL glacial acetic acid and a 1.625″ egg-shaped stir bar (Fisher Cat. No. 14-511-58B). The samples should be withdrawn starting about thirty seconds before the scheduled time so that they can be poured onto the ice at the appointed scheduled time. The mixture is stirred rapidly and charged with 5 mL of a 10% (w/v) KI solution. Development of a yellow color indicates the presence of peracid. The mixture is titrated with 0.025N sodium thiosulfate (VWR Cat. No. VW 32271) solution to the disappearance of the yellow color. The volume in mL of sodium thiosulfate solution used at the time points are designated as V₁, V₁₀, V₂₀ and V₃₀.

The weight percentage, Z, of the peracid of the detergent composition that is released after 1 min is (V₁/(V₁₀ or V₂₀ or V₃₀, whichever is greater)).

Z may be comprised between 0% and 50% and is preferably below 40%, below 30% or even below 20% or 10%.

In addition to Applicants' bleach catalysts, laundry detergent compositions must comprise a peracid source. Suitable ratios of moles of Applicants' bleach catalyst to moles of peracid source include but are not limited to from about 1:1 to about 1:1000. Suitable peracid sources include, but are not limited to, preformed peracids, a hydrogen peroxide source in combination with a bleach activator, or a mixture thereof. Suitable preformed peracids include, but are not limited to, compounds selected from the group consisting of percarboxylic acids and salts, percarbonic acids and salts, perimidic acids and salts, peroxymonosulfuric acids and salts, and mixtures thereof. Suitable sources of hydrogen peroxide include, but are not limited to, compounds selected from the group consisting of perborate compounds, percarbonate compounds, perphosphate compounds and mixtures thereof.

Suitable bleach activators include, but are not limited to, tetraacetyl ethylene diamine (TAED), 1,3,5-triacetyl-2,4-dioxohexahydro-1,3,5-triazine (TADHT), benzoylcaprolactam (BzCL), 4-nitrobenzoylcaprolactam, 3-chlorobenzoylcaprolactam, benzoyloxybenzenesulphonate (BOBS), nonanoyloxybenzenesulphonate (NOBS), phenyl benzoate (PhBz), decanoyloxybenzenesulphonate (C₁₀—OBS), benzoylvalerolactam (BZVL), octanoyloxybenzenesulphonate (C₈—OBS), perhydrolyzable esters, perhydrolyzable imides, and mixtures thereof.

The Hueing Dye

The laundry detergent composition of the invention comprises a hueing dye. The laundry detergent composition may comprise at least 0.0001 wt %, typically at least 0.0002 wt % or 0.0005, or 0.001, or even 0.002 wt % or 0.005 wt % of hueing dye. The laundry detergent composition may comprise up to 3 wt %, or up to 0.5 wt %, or up to 0.01 wt % per weight of a hueing dye.

The weight ratio, of bleach catalyst to hueing dye present in the detergent composition may be comprised between 5 and 1000, or between 10 and 500, or between 20 and 250.

The weight percentage, X, of hueing dye of the detergent composition that is released after 1 min, when 10 g of said laundry detergent composition are mixed with 1 l of deionised water at 25° C. may be measured by spectroscopy.

10 g of the detergent composition (with hueing dye but without any other dye, without bleach activator or preformed peracid) is added all at once at time zero (t=0) into 1 l of deionised water at 25° C. in a Terg-O-Tometer set to agitate at a rate of 100 per minute to form a wash liquor. At t=1 min, a 20 mL aliquot of the wash liquor is filtered through a fritted glass filter to remove undissolved particulates and 3.0 mL of filtrate is analysed. The absorbance value of the dye at the lambda max of the dye for the aliquot removed at t=1 min is designated Abs₁.

Another aliquot is removed at t=30 min, filtered and analyzed to obtain the value Abs₃₀. The weight percentage, X, of hueing dye of the detergent composition that is released after 1 min is defined as (Abs₁/Abs₃₀).

X may be comprised between 25% or even between 50% and 100% and is preferably above 75%, below 90% or even 95%.

A hueing dye of the present invention may be a water soluble or water dispersible compound.

The hueing dye present in said composition may be soluble at 25° C. in a mixture of 1 litre of deionised water and 10 g of the laundry detergent composition. A hueing dye is defined as a dye which upon washing provides white fabrics with a light off-white tint, modifying whiteness appearance and acceptance (e.g. providing aqua, or blue, or violet, or pink hue). The hueing dye may have a substantially intense color as a raw material and may color a fabric by selectively absorbing certain wavelengths of light. Preferred hueing dyes include dyes that are such that the fabrics treated with said hueing dye according to the fabric substantive component test below (test method 1) show an average difference in hue of greater than 0.1, in particular greater than 0.2 or 0.5 units on either the a axis or b axis.

Preferred hueing dye exhibits a hueing efficiency of at least 1, or of at least 2, preferably of at least 5, 10 for example of at least 15. The hueing efficiency of a dye is measured as indicated in test method 2 below and is measured by comparing a fabric sample washed in a solution containing no dye with a fabric sample washed in a solution containing the dye, and indicates if a hueing dye is effective for providing the desired tinting, for example, whitening. Suitable hueing dyes may be hueing dyes described in U.S. Pat. No. 7,208,459.

The principle feature of dyes may be a conjugated system, allowing them to absorb energy in the visible part of the spectra. The most commonly encountered conjugated systems include phthalocyanine, anthraquinone, azo, phenyl groups, referred to as chromophore. Dyes can be, but are not required to be, chosen from the following categories: reactive dyes, direct dyes, sulphur and azoic dyes, acid dyes, and disperse dyes.

The hueing dye may be a photobleach. Photobleaches are molecules which absorb the energy from sunlight and transfer it by reacting with another molecule (typically oxygen) to produce bleaching species (singlet oxygen). Photobleaches generally comprise conjugated rings, and therefore usually present a strong visible color. Typical photobleaches comprises phthalocyanines based on zinc, copper, silicon, or aluminium.

The hueing dye may have the following structure of formula I:

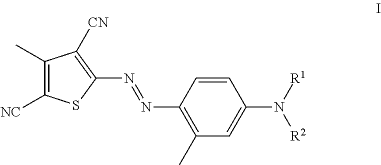

wherein each R¹ and R² are independently selected from the group consisting of R, —[(CH₂CR′HO)ₓ(CH2CR″HO)_{y}H], and mixtures thereof, wherein R is independently selected from H, C₁-C₄ linear or branched alkyl, benzyl and mixtures thereof; each R′ is independently selected from the group consisting of H, CH₂—O—(CH₂CH₂O)_{z}H, and mixtures thereof, and each R″ is selected from the group consisting of H, CH₃, CH₂—O—(CH₂CH₂O)_{z}H, and mixtures thereof; wherein x+y≦5; wherein y≧1; and wherein z=0 to 5.

The compounds of formula I, are particularly preferred and may be synthesized according to the procedure disclosed in U.S. Pat. No. 4,912,203 to Kluger et al.

In particular, the hueing dye of formula I may be one of the following compounds 1-5:

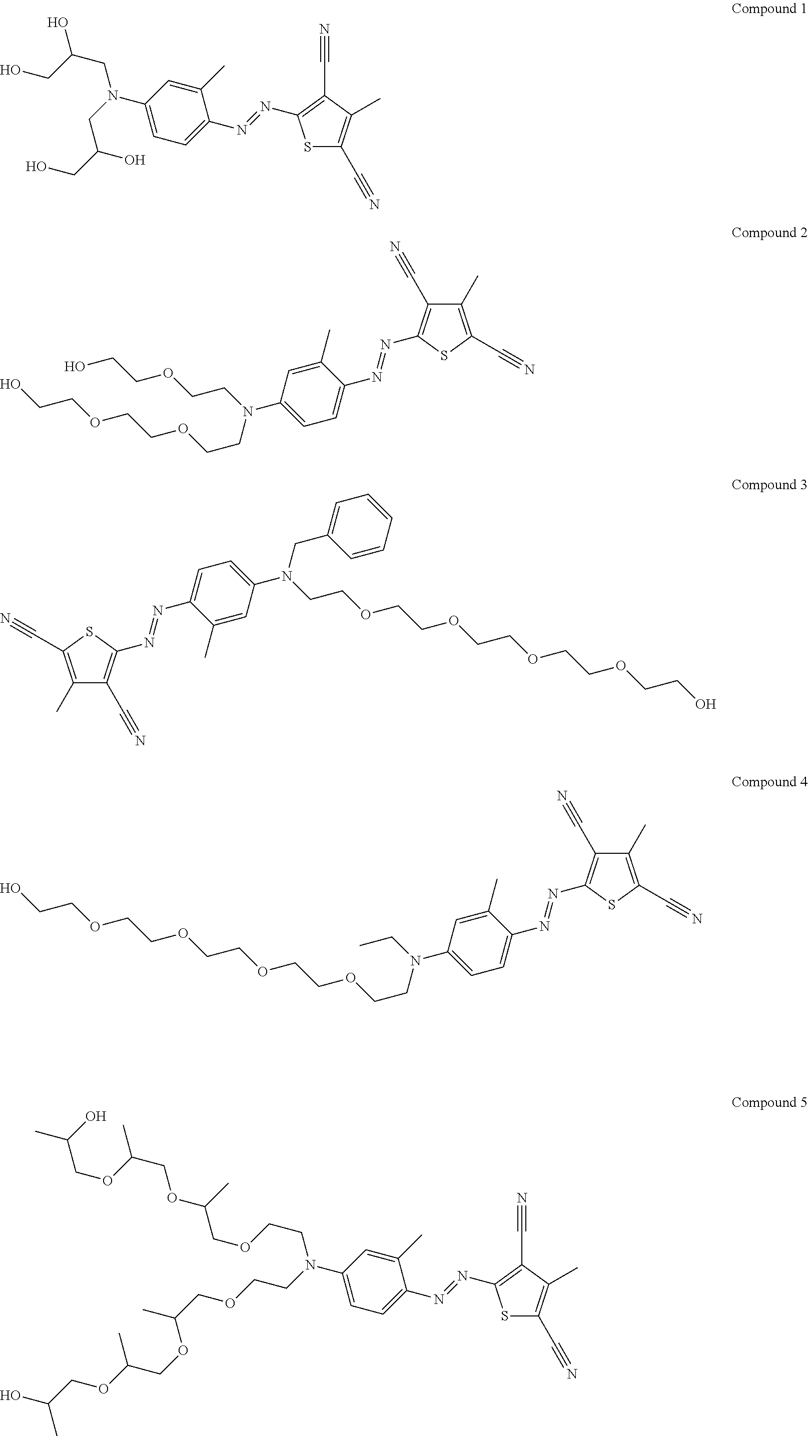

The hueing dye may be a small molecule dye or a polymeric dye. Suitable small molecule dyes include, but are not limited to, small molecule dyes selected from the group consisting of dyes falling into the Colour Index (C.I.) classifications of Direct Blue, Direct Red, Direct Violet, Acid Blue, Acid Red, Acid Violet, Basic Blue, Basic Violet and Basic Red, or mixtures thereof, for example:

### (1) Tris-Azo Direct Blue Dyes of the Formula

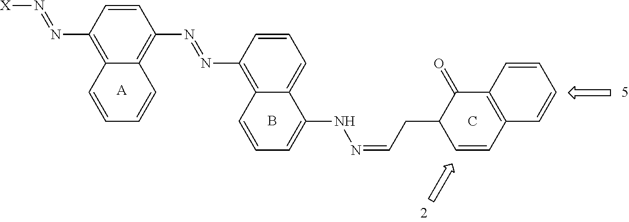

where at least two of the A, B and C naphthyl rings are substituted by a sulfonate group, the C ring may be substituted at the 5 position by an NH₂ or NHPh group, X is a benzyl or naphthyl ring substituted with up to 2 sulfonate groups and may be substituted at the 2 position with an OH group and may also be substituted with an NH₂ or NHPh group.

(2) bis-azo Direct Violet Dyes of the Formula:

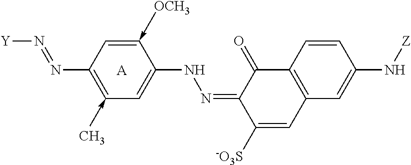

where Z is H or phenyl, the A ring is typically substituted by a methyl and methoxy group at the positions indicated by arrows, the A ring may also be a naphthyl ring, the Y group is a phenyl or naphthyl ring, which may be substituted with one or more sulphonate group(s) and may be mono or disubstituted by methyl groups.

### (3) Blue or Red Acid Dyes of the Formula

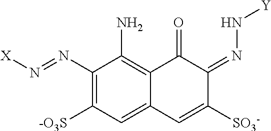

where at least one of X and Y must be an aromatic group. In one aspect, both the aromatic groups may be a substituted phenyl or naphthyl group, which may be substituted with non water-solubilising groups such as alkyl or alkyloxy or aryloxy groups, X and Y may not be substituted with water solubilising groups such as sulfonates or carboxylates. In another aspect, X is a nitro substituted phenyl group and Y is a phenyl group

### (4) Red Acid Dyes of the Structure

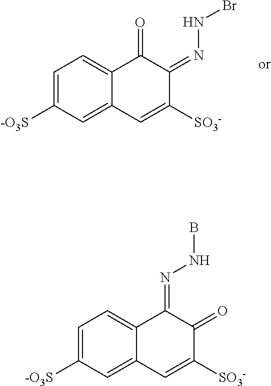

where B is a naphthyl or phenyl group that may be substituted with non water solubilising groups such as alkyl or alkyloxy or aryloxy groups, B may not be substituted with water solubilising groups such as sulfonates or carboxylates.

### (5) Dis-Azo Dyes of the Structure

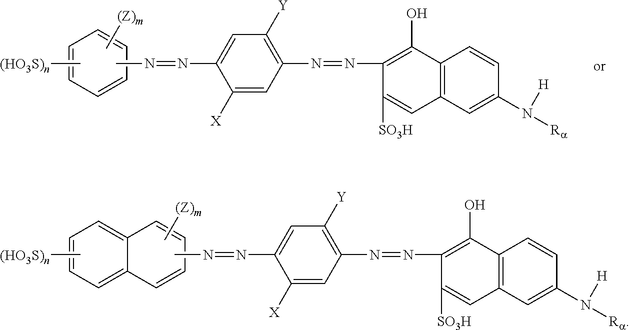

wherein X and Y, independently of one another, are each hydrogen, C₁-C₄ alkyl or C₁-C₄-alkoxy, Rα is hydrogen or aryl, Z is C₁-C₄ alkyl; C₁-C₄-alkoxy; halogen; hydroxyl or carboxyl, n is 1 or 2 and m is 0, 1 or 2, as well as corresponding salts thereof and mixtures thereof

### (6) Triphenylmethane Dyes of the Following Structures

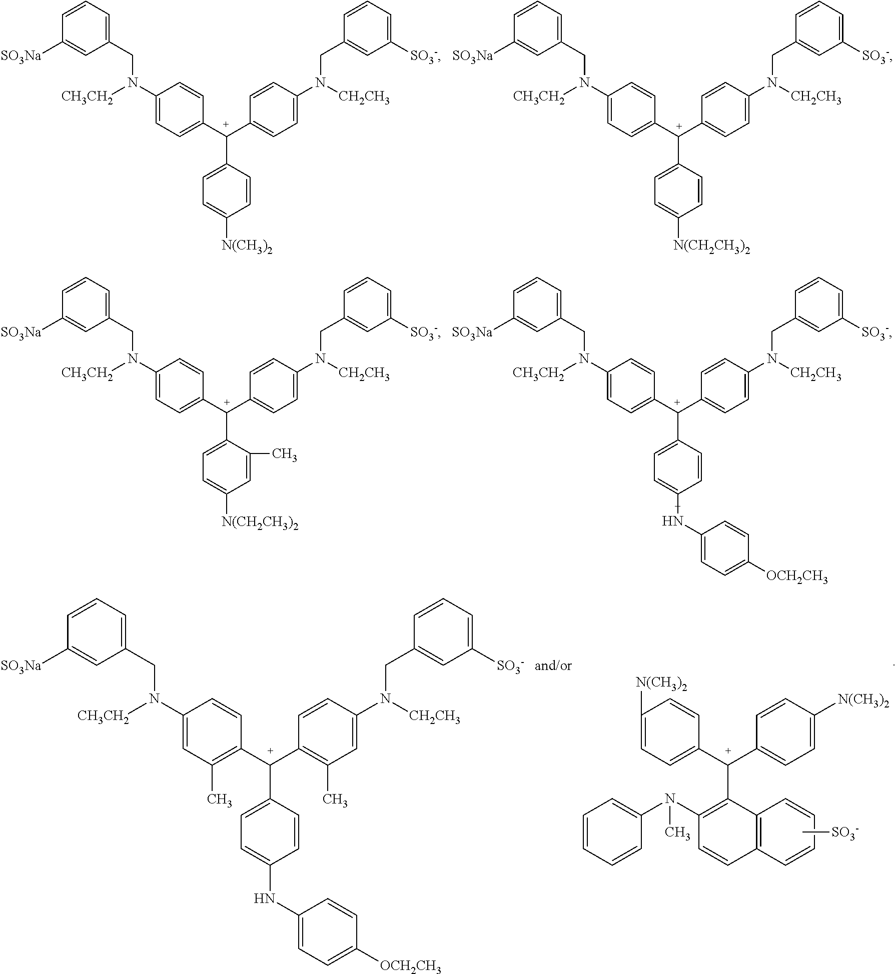

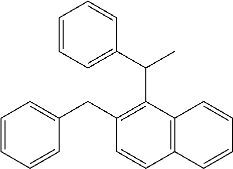

and mixtures thereof.

The hueing dye may be a small molecule dye selected from the group consisting of Colour Index (Society of Dyers and Colourists, Bradford, UK) numbers Direct Violet 9, Direct Violet 35, Direct Violet 48, Direct Violet 51, Direct Violet 66, Direct Blue 1, Direct Blue 71, Direct Blue 80, Direct Blue 279, Acid Red 17, Acid Red 73, Acid Red 88, Acid Red 150, Acid Violet 15, Acid Violet 17, Acid Violet 24, Acid Violet 43, Acid Red 52, Acid Violet 49, Acid Blue 15, Acid Blue 17, Acid Blue 25, Acid Blue 29, Acid Blue 40, Acid Blue 45, Acid Blue 75, Acid Blue 80, Acid Blue 83, Acid Blue 90 and Acid Blue 113, Acid Black 1, Basic Violet 1, Basic Violet 3, Basic Violet 4, Basic Violet 10, Basic Violet 35, Basic Blue 3, Basic Blue 16, Basic Blue 22, Basic Blue 47, Basic Blue 66, Basic Blue 75, Basic Blue 159 and mixtures thereof.

Suitable small molecule dyes may include small molecule dyes selected from 1,4-Naphthalenedione, 1-[2-[2-[4-[[4-(acetyloxy)butyl]ethylamino]-2-methylphenyl]diazenyl]-5-nitro-3-thienyl]-Ethanone, 1-hydroxy-2-(1-naphthalenylazo)-Naphthalenedisulfonic acid, ion(2-), 1-hydroxy-2-[[4-(phenylazo)phenyl]azo]-Naphthalenedisulfonic acid, ion(2-), 2-[(1E)-[4-[bis(3-methoxy-3-oxopropyl)amino]-2-methylphenyl]azo]-5-nitro-3-Thiophenecarboxylic acid, ethyl ester, 2-[[4-[(2-cyanoethyl)ethylamino]phenyl]azo]-5-(phenylazo)-3-Thiophenecarbonitrile, 2-[2-[4-[(2-cyanoethyl)ethylamino]phenyl]diazenyl]-5-[2-(4-nitrophenyl)diazenyl]-3-Thiophenecarbonitrile, 2-hydroxy-1-(1-naphthalenylazo)-Naphthalenedisulfonic acid, ion(2-), 2-hydroxy-1-[[4-(phenylazo)phenyl]azo]-Naphthalenedisulfonic acid, ion(2-), 4,4′4[[4-(dimethylamino)-2,5-cyclohexadien-1-ylidene]methylene]bis[N,N-dimethyl-Benzenamine, 6-hydroxy-5-[(4-methoxyphenyl)azo]-2-Naphthalenesulfonic acid, monosodium salt, 6-hydroxy-5-[(4-methylphenyl)azo]-2-Naphthalenesulfonic acid, monosodium salt, 7-hydroxy-8-[[4-(phenylazo)phenyl]azo]-1,3-Naphthalenedisulfonic acid, ion(2-), 7-hydroxy-8-[2-(1-naphthalenyl)diazenyl]-1,3-Naphthalenedisulfonic acid, ion(2-), 8-hydroxy-7-[2-(1-naphthalenyl)diazenyl]-1,3-Naphthalenedisulfonic acid, ion(2-), 8-hydroxy-7-[2-[4-(2-phenyldiazenyl)phenyl]diazenyl]-1,3-Naphthalenedisulfonic acid, ion(2-), Acid Black 1, Acid black 24, Acid Blue 113, Acid Blue 25, Acid blue 29, Acid blue 3, Acid blue 40, Acid blue 45, Acid blue 62, Acid blue 7, Acid Blue 80, Acid blue 9, Acid green 27, Acid orange 12, Acid orange 7, Acid red 14, Acid red 151, Acid red 17, Acid red 18, Acid red 266, Acid red 27, Acid red 4, Acid red 51, Acid red 73, Acid red 87, Acid red 88, Acid red 92, Acid red 94, Acid red 97, Acid Violet 17, Acid violet 43, Basic blue 9, Basic violet 2, C.I. Acid black 1, C.I. Acid Blue 10, C.I. Acid Blue 290, C.I. Acid Red 103, C.I. Acid red 91, C.I. Direct Blue 120, C.I. Direct Blue 34, C.I. Direct Blue 70, C.I. Direct Blue 72, C.I. Direct Blue 82, C.I. Disperse Blue 10, C.I. Disperse Blue 100, C .I. Disperse Blue 101, C.I. Disperse Blue 102, C.I. Disperse Blue 106:1, C.I. Disperse Blue 11, C.I. Disperse Blue 12, C.I. Disperse Blue 121, C.I. Disperse Blue 122, C.I. Disperse Blue 124, C.I. Disperse Blue 125, C.I. Disperse Blue 128, C.I. Disperse Blue 130, C.I. Disperse Blue 133, C.I. Disperse Blue 137, C.I. Disperse Blue 138, C.I. Disperse Blue 139, C.I. Disperse Blue 142, C.I. Disperse Blue 146, C.I. Disperse Blue 148, C.I. Disperse Blue 149, C.I. Disperse Blue 165, I. Disperse Blue 165:1, C.I. Disperse Blue 165:2, C.I. Disperse Blue 165:3, C.I. Disperse Blue 171, C.I. Disperse Blue 173, C.I. Disperse Blue 174, C.I. Disperse Blue 175, C.I. Disperse Blue 177, C.I. Disperse Blue 183, C.I. Disperse Blue 187, C.I. Disperse Blue 189, C.I. Disperse Blue 193, C.I. Disperse Blue 194, C.I. Disperse Blue 200, C.I. Disperse Blue 201, C.I. Disperse Blue 202, C.I. Disperse Blue 205, C.I. Disperse Blue 206, C.I. Disperse Blue 207, C.I. Disperse Blue 209, C.I. Disperse Blue 21, C.I. Disperse Blue 210, C.I. Disperse Blue 211, C.I. Disperse Blue 212, C.I. Disperse Blue 219, C.I. Disperse Blue 220, C.I. Disperse Blue 222, C.I. Disperse Blue 224, C.I. Disperse Blue 225, C.I. Disperse Blue 248, C.I. Disperse Blue 252, C.I. Disperse Blue 253, C.I. Disperse Blue 254, C.I. Disperse Blue 255, C.I. Disperse Blue 256, C.I. Disperse Blue 257, C.I. Disperse Blue 258, C.I. Disperse Blue 259, C.I. Disperse Blue 260, C.I. Disperse Blue 264, C.I. Disperse Blue 265, C.I. Disperse Blue 266, C.I. Disperse Blue 267, C.I. Disperse Blue 268, C.I. Disperse Blue 269, C.I. Disperse Blue 270, C.I. Disperse Blue 278, C.I. Disperse Blue 279, C.I. Disperse Blue 281, C.I. Disperse Blue 283, C.I. Disperse Blue 284, C.I. Disperse Blue 285, C.I. Disperse Blue 286, C.I. Disperse Blue 287, C.I. Disperse Blue 290, C.I. Disperse Blue 291, C.I. Disperse Blue 294, C.I. Disperse Blue 295, C.I. Disperse Blue 30, C.I. Disperse Blue 301, C.I. Disperse Blue 303, C.I. Disperse Blue 304, C.I. Disperse Blue 305, C.I. Disperse Blue 313, C.I. Disperse Blue 315, C.I. Disperse Blue 316, C.I. Disperse Blue 317, C.I. Disperse Blue 321, C.I. Disperse Blue 322, C.I. Disperse Blue 324, C.I. Disperse Blue 328, C.I. Disperse Blue 33, C.I. Disperse Blue 330, C.I. Disperse Blue 333, C.I. Disperse Blue 335, C.I. Disperse Blue 336, C.I. Disperse Blue 337, C.I. Disperse Blue 338, C.I. Disperse Blue 339, C.I. Disperse Blue 340, C.I. Disperse Blue 341, C.I. Disperse Blue 342, C.I. Disperse Blue 343, C.I. Disperse Blue 344, C.I. Disperse Blue 345, C.I. Disperse Blue 346, C.I. Disperse Blue 351, C.I. Disperse Blue 352, C.I. Disperse Blue 353, C.I. Disperse Blue 355, C.I. Disperse Blue 356, C.I. Disperse Blue 357, C.I. Disperse Blue 358, C.I. Disperse Blue 36, C.I. Disperse Blue 360, C.I. Disperse Blue 366, C.I. Disperse Blue 368, C.I. Disperse Blue 369, C.I. Disperse Blue 371, C.I. Disperse Blue 373, C.I. Disperse Blue 374, C.I. Disperse Blue 375, C.I. Disperse Blue 376, C.I. Disperse Blue 378, C.I. Disperse Blue 38, C.I. Disperse Blue 42, C.I. Disperse Blue 43, C.I. Disperse Blue 44, C.I. Disperse Blue 47, C.I. Disperse Blue 79, C.I. Disperse Blue 79:1, C.I. Disperse Blue 79:2, C.I. Disperse Blue 79:3, C.I. Disperse Blue 82, C.I. Disperse Blue 85, C.I. Disperse Blue 88, C.I. Disperse Blue 90, C.I. Disperse Blue 94, C.I. Disperse Blue 96, C.I. Disperse Violet 10, C.I. Disperse Violet 100, C.I. Disperse Violet 102, C.I. Disperse Violet 103, C.I. Disperse Violet 104, C.I. Disperse Violet 106, C.I. Disperse Violet 107, C.I. Disperse Violet 12, C.I. Disperse Violet 13, C.I. Disperse Violet 16, C.I. Disperse Violet 2, C.I. Disperse Violet 24, C.I. Disperse Violet 25, C.I. Disperse Violet 3, C.I. Disperse Violet 33, C.I. Disperse Violet 39, C.I. Disperse Violet 42, C.I. Disperse Violet 43, C.I. Disperse Violet 45, C.I. Disperse Violet 48, C.I. Disperse Violet 49, C.I. Disperse Violet 5, C.I. Disperse Violet 50, C.I. Disperse Violet 53, C.I. Disperse Violet 54, C.I. Disperse Violet 55, C.I. Disperse Violet 58, C.I. Disperse Violet 6, C.I. Disperse Violet 60, C.I. Disperse Violet 63, C.I. Disperse Violet 66, C.I. Disperse Violet 69, C.I. Disperse Violet 7, C.I. Disperse Violet 75, C.I. Disperse Violet 76, C.I. Disperse Violet 77, C.I. Disperse Violet 82, C.I. Disperse Violet 86, C.I. Disperse Violet 88, C.I. Disperse Violet 9, C.I. Disperse Violet 91, C.I. Disperse Violet 92, C.I. Disperse Violet 93, C.I. Disperse Violet 93:1, C.I. Disperse Violet 94, C.I. Disperse Violet 95, C.I. Disperse Violet 96, C.I. Disperse Violet 97, C.I. Disperse Violet 98, C.I. Disperse Violet 99, C.I. Reactive Black 5, C.I. Reactive Blue 19, C.I. Reactive Blue 4, C.I. Reactive Red 2, C.I. Solvent Blue 43, C.I. Solvent Blue 43, C.I. Solvent Red 14, C.I. Acid black 24, C.I. Acid blue 113, C.I. Acid Blue 29, C.I. Direct violet 7, C.I. Food Red 14, Dianix Violet CC, Direct Blue 71, Direct blue 75, Direct blue 78, Direct violet 11, Direct violet 31, Direct violet 5, Direct Violet 51, Direct violet 9, Disperse Blue 106, Disperse blue 148, Disperse blue 165, Disperse Blue 3, Disperse Blue 354, Disperse Blue 364, Disperse blue 367, Disperse Blue 56, Disperse Blue 77, Disperse Blue 79, Disperse blue 79:1, Disperse Red 1, Disperse Red 15, Disperse Violet 26, Disperse Violet 27, Disperse Violet 28, Disperse violet 63, Disperse violet 77, Eosin Y, Ethanol 2,2′-[[4-[(3,5-dinitro-2-thienyl)azo]phenyl]imino]bis-, diacetate (ester), Lumogen F Blue 650, Lumogen F Violet 570, N-[2-[2-(3-acetyl-5-nitro-2-thienyl)diazenyl]-5-(diethylamino)phenyl]-Acetamide, N-[2-[2-(4-chloro-3-cyano-5-formyl-2-thienyl)diazenyl]-5-(diethylamino)phenyl]-Acetamide, N-[5-[bis(2-methoxyethyl)amino]-2-[2-(5-nitro-2,1-benzisothiazol-3-yl)diazenyl]phenyl]-Acetamide, N-[5-[bis[2-(acetyloxy)ethyl]amino]-2-[(2-bromo-4,6-dinitrophenyl)azo]phenyl]-Acetamide, Naphthalimide and derivatives thereof, Oil Black 860, Phloxine B, Pyrazole, Rose Bengal, Sodium 6-hydroxy-5-(4-isopropylphenylazo)-2-naphthalenesulfonate, Solvent Black 3, Solvent Blue 14, Solvent Blue 35, Solvent Blue 58, Solvent Blue 59, Solvent Red 24, Solvent Violet 13, Solvent Violet 8, Sudan Red 380, Triphenylmethane, Triphenylmethane and derivatives thereof, or mixtures thereof.

Suitable polymeric dyes include polymeric dyes selected from the group consisting of polymers containing conjugated chromogens (dye-polymer conjugates) and polymers with chromogens co-polymerized into the backbone of the polymer and mixtures thereof.

In another aspect, suitable polymeric dyes include polymeric dyes selected from the group consisting of fabric-substantive hueing dyes of formula I above available from Milliken (Spartanburg, S.C., USA), dye-polymer conjugates formed from at least one reactive dye and a polymer selected from the group consisting of polymers comprising a moiety selected from the group consisting of a hydroxyl moiety, a primary amine moiety, a secondary amine moiety, a thiol moiety and mixtures thereof. In still another aspect, suitable polymeric dyes include polymeric dyes selected from the group consisting of carboxymethyl cellulose (CMC) conjugated with a reactive blue, reactive violet or reactive red dye such as CMC conjugated with C.I. Reactive Blue 19, sold by Megazyme, Wicklow, Ireland under the product name AZO-CM-CELLULOSE, product code S-ACMC, alkoxylated triphenyl-methane polymeric colourants, alkoxylated thiophene polymeric colourants, alkoxylated thiazolium polymeric colourants, and mixtures thereof.

The hueing dye may be part of a dye clay conjugate. Suitable dye clay conjugates include dye clay conjugates selected from the group comprising at least one cationic/basic dye and a smectite clay, and mixtures thereof. In another aspect, suitable dye clay conjugates include dye clay conjugates selected from the group consisting of one cationic/basic dye selected from the group consisting of C.I. Basic Yellow 1 through 108, C.I. Basic Orange 1 through 69, C.I. Basic Red 1 through 118, C.I. Basic Violet 1 through 51, C.I. Basic Blue 1 through 164, C.I. Basic Green 1 through 14, C.I. Basic Brown 1 through 23, CI Basic Black 1 through 11, and a clay selected from the group consisting of Montmorillonite clay, Hectorite clay, Saponite clay and mixtures thereof. In still another aspect, suitable dye clay conjugates include dye clay conjugates selected from the group consisting of: Montmorillonite Basic Blue B7 C.I. 42595 conjugate, Montmorillonite Basic Blue B9 C.I. 52015 conjugate, Montmorillonite Basic Violet V3 C.I. 42555 conjugate, Montmorillonite Basic Green G1 C.I. 42040 conjugate, Montmorillonite Basic Red R1C.I. 45160 conjugate, Montmorillonite C.I. Basic Black 2 conjugate, Hectorite Basic Blue B7 C.I. 42595 conjugate, Hectorite Basic Blue B9 C.I. 52015 conjugate, Hectorite Basic Violet V3 C.I. 42555 conjugate, Hectorite Basic Green G1 C.I. 42040 conjugate, Hectorite Basic Red R1C.I. 45160 conjugate, Hectorite C.I. Basic Black 2 conjugate, Saponite Basic Blue B7 C.I. 42595 conjugate, Saponite Basic Blue B9 C.I. 52015 conjugate, Saponite Basic Violet V3 C.I. 42555 conjugate, Saponite Basic Green G1 C.I. 42040 conjugate, Saponite Basic Red R1 C.I. 45160 conjugate, Saponite C.I. Basic Black 2 conjugate and mixtures thereof.

Relative Rate of Release of Hueing Dye and Bleach Catalyst and or Peracid.

In the laundry detergent composition of the invention, the ratio Y/X may be below 0.8, with X being the weight percentage of hueing dye of the detergent composition that is released after 1 min and Y is the weight percentage of bleach catalyst of the detergent composition that is released after 1 min, when 10 g of said laundry detergent composition are mixed with 1 l of deionised water at 25° C.

Preferably, the ratio Y/X is below 0.6 or below 0.4 or below 0.2 or below 0.1 or even below 0.05.

In the laundry detergent composition of the invention, the ratio Z/X may be below 0.8, with X being the weight percentage of hueing dye of the detergent composition that is released after 1 min and Z is the weight percentage of peracid of the detergent composition that is released after 1 min, when 10 g of said laundry detergent composition are mixed with 1 l of deionised water at 25° C.

Preferably, the ratio Z/X is below 0.6 or below 0.4 or below 0.2 or below 0.1 or even below 0.05.

To lower the ratio Y/X or the ratio Z/X, the skilled person may chose a hueing dye having a faster rate of release and/or slow down, by any known method, the rate of release of the bleach catalyst and/or of the peracid.

For example, the bleach catalyst and/or any compound that could activate the bleach catalyst like peracid sources or hydrogen peroxide sources and/or bleach activator can be encapsulated or coated.

The laundry detergent composition may comprise a layered particle comprising a core and a layer, said core comprising a hydrogen peroxide source and said layer comprising a binder and/or a bleach activator. Said hydrogen peroxide source and said bleach activator may be present in said layered particle at a weight ratio of from about 5:1 to about 1.1:1, or from about 4:1 to about 1.5:1, or about 2:1. The laundry detergent composition may comprise from about 0.01% to about 50%, or from about 0.1% to about 20%, or from about 1% to about 10%, or from about 2% to about 5% of the layered particle.

In one aspect, the layered particle may have an average diameter of from about 600 μm to 2000 μm, or from about 800 μm to about 1000 μm. In one aspect, the layer of the layered particle may have a thickness of from about 25 μm to about 150 μm, or from about 40 μm to about 100 μm.

In one aspect, the binder may comprise, based on total layered particle weight, from about 2% to about 15%, or from about 6% to about 10%, or about 7% of the layered particle. The binder may comprise, based on total layered particle weight, from about 0.001% to about 5%, or from about 0.5% to about 3%, or about 1% to about 2% water. In one aspect, the binder may be substantially free of water. In one aspect, the binder may be capable of absorbing from about 0.1% to about 20%, or from about 1% to about 15%, or from about 2% to about 10% water by weight of the binder over a relative humidity of 80% at 32° C. In one aspect, the binder may have a viscosity of from about 200 to about 20,000, or from about 500 to about 7,000, or from about 1,000 to about 2,000 centipoises at a shear rate of 25 sec-1 at 25° C. In one aspect, the binder may have a pH, as measured as a 10% solution in water, of from about 3 to about 9, or from about 5 to about 8, or from about 6 to about 7.

In one aspect, the binder may comprise, based on total binder weight, from about 40% to 100%, or about 50% to about 99% of a surfactant material selected from the group consisting of anionic surfactant, nonionic surfactant, and combinations thereof. In one aspect, the binder may comprise alcohol ethoxylate and linear alkylbenzene sulfonate. In one aspect, the binder may comprise, based on total binder weight, from about 60% to about 100%, or about 70% to about 90%, of a non-surfactant material comprising a hydrocarbon material selected from the group consisting of fats, triglycerides, lipids, fatty acids, soft paraffin wax, and combinations thereof. In one aspect, the binder may comprise a solvent.

In another aspect, the binder may comprise an additive selected from the group consisting of acidic materials, moisture sinks; gelling agents; antioxidants; and combinations thereof.

### Laundry Detergent Composition

The laundry detergent composition may be in solid form, or may be a colloidal composition comprising solid suspended particles.

Preferably, the laundry detergent composition comprises a source of hydrogen peroxide. The source of hydrogen peroxide may be part of a layered particle. The source of hydrogen peroxide may comprise a per-compound. The source of hydrogen peroxide may comprise a material selected from the group consisting of sodium perborate in mono-hydrate or tetra-hydrate form or mixtures thereof; sodium percarbonate; and combinations thereof. In one aspect, the source of hydrogen peroxide may be sodium percarbonate. In one aspect, the sodium percarbonate may be in the form of a coated percarbonate layered particle.

The detergent composition preferably comprises a bleach activator. The bleach activator may be part of a layered particle. The bleach activator may comprise a material selected from the group consisting of tetraacetyl ethylene diamine; oxybenzene sulphonate bleach activators, such as nonanoyl oxybenzene sulphonate; caprolactam bleach activators; imide bleach activators, such as N-nonanoyl-N-methyl acetamide; decanoyloxybenzenecarboxylic acid; amido-derived bleach activator; benzoxazin-type activator; acyl lactam activator; and combinations thereof. In one aspect, the bleach activator may comprise nonanoyl oxybenzene sulphonate (NOBS), available from Future Fuel Company, Batesville Ark., tetraacetyl ethylene diamine (TAED), decanoyloxybenzenecarboxylic acid (DOBA), and combinations thereof. In another aspect, the bleach activator may comprise tetraacetyl ethylene diamine.

In one aspect, the bleach activator may comprise an amido-derived bleach activators of the formulae:

R₁N(R₅)C(O)R₂C(O)L or R₁C(O)N(R₅)R₂C(O)L

wherein as used for these compounds R₁ may be an alkyl group containing from about 6 to about 12 carbon atoms, R₂ may be an alkylene containing from 1 to about 6 carbon atoms, R₅ is H or alkyl, aryl, or alkaryl containing from about 1 to about 10 carbon atoms, and L is any suitable leaving group. A leaving group is any group that is displaced from the bleach activator as a consequence of the nucleophilic attack on the bleach activator by the hydroperoxide anion. In one aspect, the leaving group may be oxybenzenesulfonate. In one aspect, the bleach activators may comprise (6-octanamido-caproyl)oxybenzenesulfonate, (6-nonanamido-caproyl)oxybenzenesulfonate, (6-decanamido-caproyl)oxybenzenesulfonate, and mixtures thereof.

In one aspect, the bleach activator may comprise a bleach activator of the benzoxazin-type and may comprise:

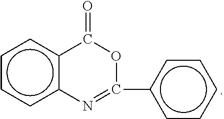

In one aspect, the bleach activator may be an acyl lactam activator of the formulae:

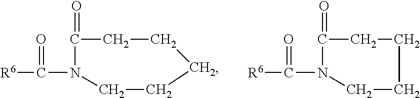

wherein as used for these compounds R⁶ may be H or an alkyl, aryl, alkoxyaryl, or alkaryl group containing from 1 to about 12 carbon atoms. In this aspect, the bleach activator may be acyl caprolactams and acyl valerolactams. In one aspect, the bleach activator may be selected from the group consisting of benzoyl caprolactam, octanoyl caprolactam, 3,5,5-trimethylhexanoyl caprolactam, nonanoyl caprolactam, decanoyl caprolactam, undecenoyl caprolactam, benzoyl valerolactam, octanoyl valerolactam, decanoyl valerolactam, undecenoyl valerolactam, nonanoyl valerolactam, 3,5,5-trimethylhexanoyl valerolactam and mixtures thereof. Non-limiting examples of suitable bleach activators are disclosed in U.S. Pat. Nos. 4,915,854, 4,412,934, 4,634,551, 4,966,723, 4,545,784

The laundry detergent composition may comprise further adjunct ingredients. While not essential, the non-limiting list of adjuncts illustrated hereinafter are suitable for use in the instant compositions and may be desirably incorporated in certain aspects, for example to assist or enhance cleaning performance, for treatment of the substrate to be cleaned, or to modify the aesthetics of the cleaning composition as may be the case with perfumes, colorants, or the like. The precise nature of these additional components, and levels of incorporation thereof, will depend on the physical form of the composition and the nature of the cleaning operation for which it is to be used. Suitable adjunct materials include, but are not limited to, surfactants, builders, chelating agents, dye transfer inhibiting agents, dispersants, enzymes, and enzyme stabilizers, polymeric dispersing agents, structurants, clay soil removal/anti-redeposition agents, brighteners, suds suppressors, perfumes, structure elasticizing agents, fabric softeners, carriers, hydrotropes, processing aids, solvents and/or pigments.

In certain aspects, the disclosed compositions do not contain one or more of the following adjuncts materials: surfactants, builders, chelating agents, dye transfer inhibiting agents, dispersants, enzymes, and enzyme stabilizers, catalytic materials, bleach activators, hydrogen peroxide, preformed peracids, polymeric dispersing agents, clay soil removal/anti-redeposition agents, brighteners, suds suppressors, perfumes, structure elasticizing agents, fabric softeners, carriers, hydrotropes, processing aids, solvents and/or pigments. However, when one or more adjuncts are present, such one or more adjuncts may be present as detailed below:

Surfactants—The cleaning compositions according to the present invention may comprise a surfactant or surfactant system wherein the surfactant can be selected from nonionic surfactants, anionic surfactants, cationic surfactants, ampholytic surfactants, zwitterionic surfactants, semi-polar nonionic surfactants and mixtures thereof. When present, surfactant may be present at a level of from about 0.1% to about 60%, from about 1% to about 50% or even from about 5% to about 40% by weight of the subject composition.

Builders—The cleaning compositions of the present invention may comprise one or more detergent builders or builder systems. When a builder is used, the subject composition may comprise at least about 1%, from about 5% to about 60% or even from about 10% to about 40% builder by weight of the subject composition. Builders include the alkali metal, ammonium and alkanolammonium salts of polyphosphates, alkali metal silicates, alkaline earth and alkali metal carbonates, aluminosilicate builders and polycarboxylate compounds, ether hydroxypolycarboxylates, copolymers of maleic anhydride with ethylene or vinyl methyl ether, 1,3,5-trihydroxy benzene-2,4,6-trisulphonic acid, and carboxymethyloxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, citric acid, oxydisuccinic acid, polymaleic acid, benzene 1,3,5-tricarboxylic acid, carboxymethyloxysuccinic acid, and soluble salts thereof.

Chelating Agents—The cleaning compositions herein may contain a chelating agent. Suitable chelating agents include, but are not limited to, copper, iron and/or manganese chelating agents and mixtures thereof. When a chelating agent is used, the subject composition may comprise from about 0.005% to about 15% or even from about 3.0% to about 10% chelating agent by weight of the subject composition.

Dye Transfer Inhibiting Agents—The cleaning compositions of the present invention may also include, but are not limited to, one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in a subject composition, the dye transfer inhibiting agents may be present at levels from about 0.0001% to about 10%, from about 0.01% to about 5% or even from about 0.1% to about 3% by weight of the composition.

Brighteners—The cleaning compositions of the present invention can also contain additional components that may tint articles being cleaned, such as fluorescent brighteners. Suitable fluorescent brightener levels include lower levels of from about 0.01, from about 0.05, from about 0.1 or even from about 0.2 wt % to upper levels of 0.5 or even 0.75 wt %.

Dispersants—The compositions of the present invention can also contain dispersants. Suitable water-soluble organic materials include, but are not limited to, the homo- or co-polymeric acids or their salts, in which the polycarboxylic acid comprises at least two carboxyl radicals separated from each other by not more than two carbon atoms.

Enzymes—The cleaning compositions can comprise one or more enzymes which provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination is an enzyme cocktail that may comprise, for example, a protease and lipase in conjunction with amylase. When present in a the composition, the aforementioned enzymes may be present at levels from about 0.00001% to about 2%, from about 0.0001% to about 1% or even from about 0.001% to about 0.5% enzyme protein by weight of the composition.

Enzyme Stabilizers—Enzymes for use in detergents can be stabilized by various techniques. The enzymes employed herein can be stabilized by the presence of water-soluble sources of calcium and/or magnesium ions in the finished compositions that provide such ions to the enzymes. In case of aqueous compositions comprising protease, a reversible protease inhibitor, such as a boron compound, can be added to further improve stability.

Catalytic Metal Complexes—the compositions may include catalytic metal complexes. One type of metal-containing bleach catalyst is a catalyst system comprising a transition metal cation of defined bleach catalytic activity, such as copper, iron, titanium, ruthenium, tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra(methylenephosphonic acid) and water-soluble salts thereof. Such catalysts are disclosed in U.S. Pat. No. 4,430,243. If desired, the compositions herein can be catalyzed by means of a manganese compound. Such compounds and levels of use are well known in the art and include, but are not limited to, for example, the manganese-based catalysts disclosed in U.S. Pat. No. 5,576,282.

Compositions herein may also include a transition metal complex of ligands such as bispidones and/or macropolycyclic rigid ligands—abbreviated as “MRLs”. As a practical matter, and not by way of limitation, the compositions and processes herein can be adjusted to provide on the order of at least one part per hundred million of the active MRL species in the aqueous washing medium, and will typically provide from about 0.005 ppm to about 25 ppm, from about 0.05 ppm to about 10 ppm, or even from about 0.1 ppm to about 5 ppm, of the MRL in the wash liquor. Suitable transition-metals in the instant transition-metal bleach catalyst include, but are not limited to, for example, manganese, iron and chromium. Suitable MRLs include, but are not limited to, 5,12-diethyl-1,5,8,12-tetraazabicyclo[6.6.2]hexadecane. The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Unless otherwise specified, ratio and percentage are in weight.

The following examples are given by way of illustration only and therefore should not be construed to limit the scope of the invention.

### EXAMPLES

### Example I

### Preparation of Propandiol Binder

72 grams of micronized sodium carbonate, d50 of 20 microns, is dispersed into 600 g of propanediol, available from VWR, using a high shear mixer for 1 min. The propanediol and carbonate mixture is transferred into the bowl of a Kenwood Chef kMixer. 400 g of HLAS, available from Sasol, (˜60° C.) is slowly added to the propanediol and carbonate with the mixer on at setting of 3-4 to avoid excessive foaming. After addition of HLAS, the mix is allowed to mix for 1 minute. The mix is then allowed to de-aerate in a 60° C. oven. Any unreacted carbonate at the bottom of the mix is separated off. The pH is then adjusted to between 4 to 10 by addition of carbonate or HLAS. The mix is then de-aerated as above, and any further unreacted carbonate is separated from the mix. The final pH of the mix is between 5 and 6.

### Example II

### Preparation of Nonionic/LAS Binder

72 g micronized sodium carbonate, d50 of 20 microns; is mixed into 600 g Neodol 45-7, available from Shell Chemicals, (nonionic surfactant) using a high shear mixer for 1 min. The nonionic/carbonate blend is transferred into the bowl of a Kenwood Chef kMixer. 400 grams of HLAS is slowly added into the nonionic/carbonate blend using continuous mixing to avoid excessive foaming. After addition of HLAS, the mix is allowed to mix for 1 minute. The mix is then allowed to de-aerate in a 60° C. oven. Any unreacted carbonate at the bottom of the mix is separated off. The pH is then adjusted to between 4 to 10 by addition of either carbonate or HLAS. The mix is then de-aerated as above, and any further unreacted carbonate is separated from the mix. The final pH of the mix is between 5 and 6

### Example III

### Preparation of Layered Particles

400 g of sodium percarbonate (Ecox-C™, available from Kemira, Finland) is mixed with 20.4 g of the propanediol binder in a Braun K 700 Food Processor until the mixture is visibly sticky. 200 g of TAED Powder, (available from Warwick International, Mostyn, Flintshire, U.K.) is then added. A further 12.3 g of the binder is then added with mixing. 30.5 g of carboxymethylcellulose, available under the tradename Finnfix® CMC, from CP Kelco is then added as a dusting agent to coat the particle.

### Example IV

### Preparation of Layered Particles

400 g of sodium percarbonate (Ecox-C™, available from Kemira, Finland) is mixed with 24 g of the nonionic/LAS binder in a Braun K 700 Food Processor until the mixture is visibly sticky. 200 g of TAED Powder, (available from Warwick International, Mostyn, Flintshire, U.K.) is then added. A further 11 g of binder is then added with mixing. 30.5 g of carboxymethylcellulose, available under the tradename Finnfix® CMC, from CP Kelco is then added as a dusting agent to coat the particle.

### Example V

### Preparation of Detergent Material

A detergent blown powder is prepared as follows. A batch of slurry is prepared from the following materials:

| | |
|---|---|
| 52.7 kg | 1.6 ratio silicate solution (42% active), available |
| | from Solvay. |
| 114.36 kg | Sokalan CP 5 polymer solution (40% active), polymer |
| | available from BASF |
| 71.75 kg | 45% active solution of linear alkyl sulphonate (LAS) |
| 169.64 kg | light carbonate (available from Brunner-Mond, |
| | Cheshire UK) |

Identical batches are made during production as required. 10 bar steam is added as required to maintain temperature. During transfer to the spray nozzle at a rate of 1 t/hr, 146.4 kg/hr of HLAS and 38.5 kg/hr of 50% sodium hydroxide solution are injected into the slurry-containing line so as to increase the surfactant level in the slurry. The temperature of the slurry in the line just prior to spraying is 125° C. 1-3 kg/hr of high pressure air is optionally injected into the slurry line to further lower density. The resulting slurry is then sprayed through a Spray Systems T4 nozzle into a counter-current tower where it is dried by 7500-8000 kg/hr of air at temperatures between 280 to 300° C. A blown powder of average repour cup density 300 g/l, a median particle size of 450 microns and an average moisture level of 1.75% is obtained. The blown powder is then further combined with a surfactant and polymer paste as follows:

100 g of a 70% active C₂₄ AE₁S paste is blended in a food processor with 31.7 g of 73% active PEG-PVAc (polyethylene glycol-polyvinyl acetate) polymer solution. 19.86 g of the above paste is then dispersed by hand into 100 g of the above blown powder. Following this the mix is mixed in a kitchen food processor at low speed for 30 seconds to further disperse the paste mix. 3.12 g of zeolite A is then added and mixed for a further 5 seconds at low speed. The resulting powder is then pushed through a 1.7 mm sieve to ensure no oversize. This process is repeated 10 times.

A 1 kg batch of finished detergent product is prepared as follows:

622.2 g of the above blown powder/surfactant paste mix is then mixed with further detergent ingredients in the proportions shown below:

| | |
|---|---|
| Dense sodium carbonate (anhydrous)¹ | 56.01 g |
| Percarbonate/TAED from Example V | 120.0 g |
| 2% active Bleach Catalyst² | 20.0 g |
| Sodium sulphate³ | 14.0 g |
| Cationic quaternary ammonium surfactant agglomerate | 36.63 g |
| (25% active, balance zeolite A⁴) | |
| Soil release polymer | 1.22 g |
| CMC | 8.66 g |
| Enzymes | 14.92 g |
| Hueing dye (Liquitint ® Violet DD available | 0.001 g |
| from Milliken South Carolina USA) | |
| Minors/chelants/misc | to 1000 g |

¹Available from Brunner-Mond, Cheshire, UK
²2-[3-[(2-butyloctyl)oxy]-2-(sulfooxy)propyl]-3,4-dihydroisoquinolinium, inner salt, available from BASF
³Available from Crimidesa, Spain
⁴Zeolite available from Ineos Silicas, Netherlands

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention

What is claimed is:

1. Laundry detergent composition comprising:
bleach catalyst of formula: 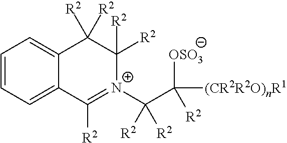
wherein R¹ is selected from the group consisting of: H, a branched alkyl group containing from 3 to 24 carbons, and a linear alkyl group containing from 1 to 24 carbons; R² is independently selected from the group consisting of: H, a branched alkyl group comprising from 3 to 12 carbons, and a linear alkyl group comprising from 1 to 12 carbons; n is an integer from 0 to 1;
hueing dye, and
a source of peracid,
wherein either Y/X is below 0.8, with X being the weight percentage of hueing dye of the detergent composition that is released in the wash liquor after 1 min, and Y being the weight percentage of said bleach catalyst that is released in the wash liquor after 1 min, when 10 g of said laundry detergent composition are mixed with 1 l of deionised water at 25° C. to form a wash liquor, or wherein Z/X is below 0.8, with X being the weight percentage of hueing dye of the detergent composition that is released in the wash liquor after 1 min, and Z being the weight percentage of peracid that is released in the wash liquor after 1 min, when 10 g of said laundry detergent composition are mixed with 1 l of deionised water at 25° C. to form a wash liquor.

2. The laundry detergent composition according to claim 1, wherein the weight ratio Y/X is below 0.8.

3. The laundry detergent composition according to claim 1, wherein the weight ratio Z/X is below 0.8.

4. The laundry detergent composition according to claim 1, wherein the bleach catalyst has a structure corresponding to general formula below: 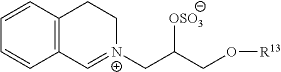
wherein R¹³ is selected from a branched alkyl group containing from three to 24 carbon atoms (including the branching carbon atoms) or a linear alkyl group containing from one to 24 carbon atoms.

5. The laundry detergent composition according to claim 1, wherein X is above 50%.

6. The laundry detergent composition according to claim 1, wherein Y is below 40%.

7. The laundry detergent composition according to claim 1, wherein Z is below 40%.

8. The laundry detergent composition according to claim 1, wherein the ratio of the weight concentration of peracid to hueing dye in the wash liquor is below 0.8, when 10 g of said laundry detergent composition are mixed with 1 l of deionised water at 25° C. to form a wash liquor.

9. The laundry detergent composition according to claim 1, wherein the source of peracid is in a layered particle.

10. The laundry detergent composition according to claim 1, comprising source of hydrogen peroxide.

11. The laundry detergent composition according to claim 10, wherein the source of hydrogen peroxide is in a layered particle.
